(19) United States
(12) Patent Application Publication
(10) Pub. No.: US 2013/0288499 A1
(43) Pub. Date: Oct. 31, 2013

(54) ELECTRICAL BRACKETS FOR FLUORESCENT BULB

(71) Applicant: Ervin Hoffman, Brooklyn, NY (US)

(72) Inventor: Ervin Hoffman, Brooklyn, NY (US)

(21) Appl. No.: 13/732,359

(22) Filed: Dec. 31, 2012

Related U.S. Application Data
(60) Provisional application No. 61/582,338, filed on Dec. 31, 2011.
(60) Provisional application No. 61/587,679, filed on Jan. 18, 2012.

(51) Int. Cl. H01R 33/08

(52) U.S. Cl. CPC H01R 33/0836
USPC 439/239

(57) ABSTRACT

A pair of electrical engagement brackets for a multiple pin fluorescent bulb. A first bracket is configured with two horizontal apertures on an inside face of the bracket. Each bracket is dimensionally sized and spaced from the other to permit insertion engagement and holding of two end pins of one end of the fluorescent bulb. The horizontal apertures are each sized to permit the other end of the bulb to be vertically moved for engagement with an opposite facing bracket. The opposite facing bracket is configured with two vertical slots with a lower end open access, wherein the vertical slots are positioned and configured to permit two other end pins of the fluorescent bulb to be inserted therein by an upward vertical movement. Electrically conductive spring like metal members extend into a path of the vertical slots such that the electrically conductive spring like metal members holdingly and electrically engage the opposite end pins of the fluorescent bulb whereby the bulb extends along an axis parallel to the fixture base of the brackets.

### FIELD OF THE INVENTION

This invention relates to electrical brackets for long tube type fluorescent bulbs and particularly to such bulbs having multiple end pin connectors such as the ubiquitous 40 watt fluorescent bulbs with double end pin connection elements.

### BACKGROUND

The design of standard fluorescent bulbs has not changed for decades, not have the brackets and electrical fixtures for such bulbs changed in any significant manner. A typical and standard four foot fluorescent bulb has two pairs of aligned pin connectors on the two ends thereof. Other multiple pin fluorescent bulbs are of various sizes and include 14, 15, 20 and 40 and watt usage (the common four foot bulbs are generally 40 watts). Electrical brackets for such bulbs come in pairs usually fixedly arranged on a fixture. Each one of the members of the bracket pair are identically configured and facingly positioned on the fixtures at a distance slightly larger than the length of a bulb and less than the bulb length with the pins (i.e., the pins are retained within the brackets). Each bracket has an open single vertical slot, an internal central vertical open insulative track and an outer open circular track channel with retained spring-like metal elements, which physically and electrically engage the bulb pins. Engagement of the pins with the metal elements effects an electrical connection to a power source to thereby light the bulb.

Installing a fluorescent bulb having multiple pins into the fixture brackets requires an initial vertical alignment of the pins of a first end of a fluorescent bulb and the vertical slot. The pins of one end of the bulb is pushed into the single vertical slot, with full insertion of both pins into the vertical slot and central track. The second end of the bulb is then aligned (sequence of alignment and insertion may vary and may even be simultaneous) with the vertical slot of a second facing bracket at the other end of the fixture and with a similar full insertion of both pins into the vertical slot and vertical channel, while holding and maintaining the first end in position. Full insertion of each pair of pins enables both pins to be positioned in the outer open circular track. The bulb is then rotated around an axis passing through both brackets, with the pins moving in the outer open circular track into engagement with the spring-like metal elements to effect an electrical connection and lighting of the bulb. Many problems often manifest themselves with such procedure especially with fixtures having multiple sets of paired brackets for use with multiple bulbs, with restricted access and with ceiling fixtures requiring arm extension installation. Failure to fully insert the pins may result in damage to the pins when the bulb is rotated with the pins outside of the circular track or if one of the pins is actually outside of the bracket.

### SUMMARY OF THE INVENTION

It is an object of the present invention to modify the structure of the existing brackets to eliminate the currently used rotation engagement and activation.

It is a further object of the present invention to provide such structure with a simple positive engagement of a first pair of pins on one end of the fluorescent bulb and a simple linear movement of the second pair of pins and fluorescent bulb end to complete an electrical connection.

Generally the present invention comprises a pair of electrical engagement brackets for a multiple pin fluorescent bulb such as the bulbs with 14, 15, 20 and 40 watt usage with a four foot bulb using 40 watts. In a first embodiment, a first bracket is configured with two horizontal apertures on the inside face of the bracket, each dimensionally sized and spaced from each other to permit insertion engagement and holding of the two end pins of one end of the fluorescent bulb. The apertures are sized to permit the other end of the bulb to be vertically moved for engagement with an opposite facing bracket. The opposite facing bracket is configured with two vertical slots with a lower end open access. The vertical slots are positioned and configured to permit the two other end pins of the fluorescent bulb to be inserted therein by an upward vertical movement. Electrically conductive spring like metal members extend into the path of the vertical slots such that they holdingly and electrically engage the opposite end pins of the fluorescent bulb whereby the bulb extend along an axis parallel to the fixture base of the brackets.

The slotted bracket comprises an external accessible disengaging member configured to effect disengagement of the second pair of fluorescent end-pins from the spring like metal members which hold the pins in the slots. This disengagement permits the end of the fluorescent bulb to be removed from the vertical slots and the fluorescent bulb to be removable from the fixture such as for replacement.

In a preferred embodiment the apertured bracket is provided with a facing button or pin, which effects electrical contact within the bracket. The button is depressed and full electrical connection is made when the fluorescent bulb installation is complete. Until such time no end of the fluorescent becomes live with an exposed electrical contact.

In a second embodiment, both brackets are, for economical considerations, identically configured with upward insertion slots, with the pins on both ends of the fluorescent bulb being held by the interior spring like metal members, which also provide the electrical contact. In this embodiment only one of the brackets need be provided with the release mechanism to release the pins since once the pins of the first side are released and the pins are removed from the bracket the pin of the other side can simply be pulled from the bracket to remove the fluorescent bulb from the fixture.

The above and other objects, features and advantages of the present invention will become more evident from the figures which:

### SHORT DESCRIPTION OF THE DRAWINGS

FIG. 1 is a depiction of a single prior art fluorescent bulb fixture bracket from the pin insertion side;

FIG. 2 is a view of a first embodiment of the bracket of the present invention with pin insertion apertures and electrical connection activation element;

FIG. 3-6 and 8 are cross section views of pin sliding slotted brackets of the present invention with various embodiments of electrical engagement elements with operation releasing plungers;

FIG. 7 is a view of the slotted bracket from the slide insertion side, for the fluorescent bulb pins; and

FIG. 9 is a view of an embodiment adaptable to both slotted and aperture insertion and is of simplified design.

### DETAILED DESCRIPTION

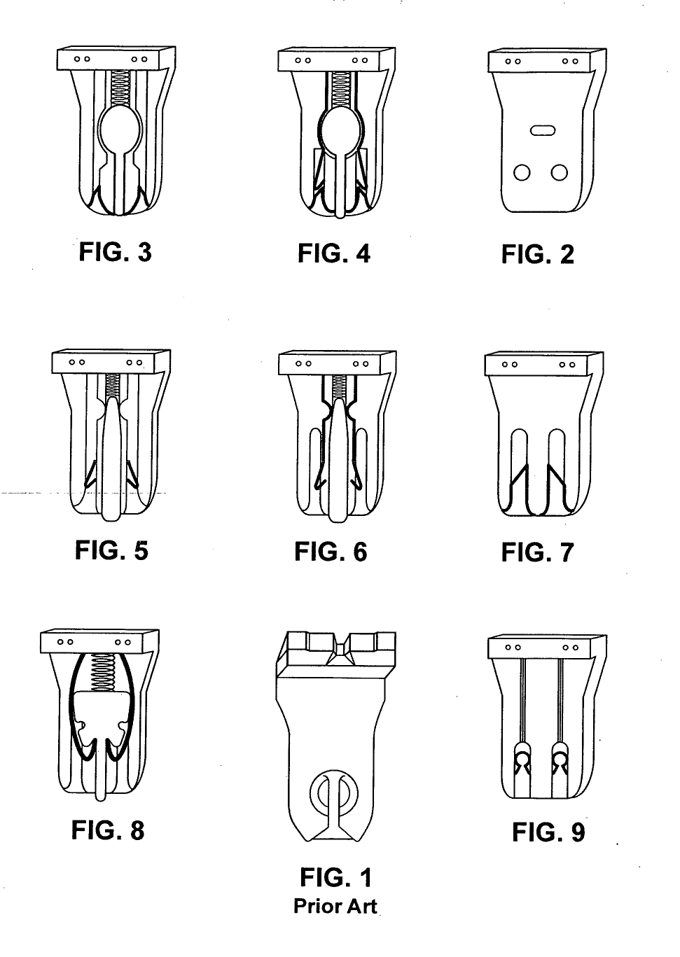

The Figures provide a contrast between the prior art bracket of FIG. 1 requiring a vertically aligned pin insertion and twisting, with the direct horizontal aperture insertion of the bracket in FIG. 2 and the horizontal upward sliding insertion in the bracket of FIG. 7. FIGS. 3-6 and 8 show various electrical contacts within the bracket and plunger configurations, which permit disengagement of the inserted pin from the spring-loaded supporting and holding metal electrical contact elements for bulb removal. FIG. 9 shows an apertured bracket with sliding slides of simplified structure.

What is claimed is:

1. A pair of electrical engagement brackets for a multiple pin fluorescent bulb with a first bracket being configured with two horizontal apertures on an inside face of the bracket, each bracket being dimensionally sized and spaced from the other to permit insertion engagement and holding of two end pins of one end of the fluorescent bulb, the horizontal apertures are each sized to permit the other end of the bulb to be vertically moved for engagement with an opposite facing bracket nd with the opposite facing bracket being configured with two vertical slots with a lower end open access, wherein the vertical slots are positioned and configure to permit two other end pins of the fluorescent bulb to be inserted therein by an upward vertical movement, with electrically conductive spring like metal members extending into a path of the vertical slots such that the electrically conductive spring like metal members holdingly and electrically engage the opposite end pins of the fluorescent bulb whereby the bulb extends along an axis parallel to the fixture base of the brackets.

2. The brackets of claim 1 wherein the slotted bracket comprises an externally accessible disengaging member configured to effect disengagement of the second pair of fluorescent end-pins from the spring like metal members which hold the pins in the slots with disengagement permitting the end of the fluorescent bulb to be removed from the vertical slots and the fluorescent bulb to be removable from the fixture.
